(19) United States
(12) Patent Application Publication
(10) Pub. No.: US 2002/0172305 A1
(43) Pub. Date: Nov. 21, 2002

(54) Fixed decision delay detectors for timing recovery loop

(76) Inventors: Younggyun Kim, Irvine, CA (US); Bhavesh G. Bhakta, Plano, TX (US); David R. Gruetter, Fullerton, CA (US)

Correspondence Address: TEXAS INSTRUMENTS INCORPORATED, P O BOX 655474, M/S 3999, DALLAS, TX, 75265

(21) Appl. No.: 09/991,595

(22) Filed: Nov. 21, 2001

Related U.S. Application Data
(60) Provisional application No. 60/252,972, filed on Nov. 24, 2000.

(51) Int. Cl. H04L 27/06

(52) U.S. Cl. 375/340

(57) ABSTRACT

A data detectors have been invented featuring a fixed decision delays. The detector is comprised of a preliminary detector working on a single sample and releasing a few probably decisions and a signal, pace detector making a final selection among these probable decisions. The final decision is made based on a finite number of observation samples. The signal space detector consists of filter bank, slicers, and a Boolean logic (circuit?).

### FIELD OF THE INVENTION

The present invention relates to disk drives. More particularly, the present invention relates to a data detector wherein the data detector detects data encoded according to a code having time varying constraints.

### BACKGROUND OF THE INVENTION

A typical disk drive includes one or more disks mounted for rotation on a hub or spindle. A typical disk drive also includes a transducer supported by a hydrodynamic air bearing which flies above each disk. The transducer and the hydrodynamic air bearing are collectively referred to as a data head. A drive controller is conventionally used for controlling the disk drive based on commands received from a host system. The drive controller controls the disk drive to retrieve information from the disks and to store information on the disks.

In one conventional disk drive, an electromechanical actuator operates within a negative feedback, closed-loop servo system. The actuator moves the data head radially over the disk surface for track seek operations and holds the transducer directly over a track on the disk surface for track following operations.

Information is typically stored in concentric tracks on the surface of the disks by providing a write signal to the data head to write information on the surface of the disk representing the data to be stored. In retrieving data from the disk, the drive controller controls the electromechanical actuator so that the data head flies above the disk and generates a read signal based on information stored on the disk. The read signal is typically conditioned and then decoded by the drive controller to recover the data.

A typical read channel includes the data head, preconditioning logic (such as preamplification circuitry and filtering circuitry), a data detector and recovery circuit, and error detection and correction circuitry. The read channel is typically implemented in a drive controller associated with the disk drive.

In disk drives, it is important that the error rate per number of bits recorded (the bit error rate [BER]) be maintained at a relatively low level. In order to improve the bit error rate performance in disk drives, or in order to increase the linear recording density in disk drives, maximum likelihood sequence detection (MLSD) methods are desired. Such methods can be implemented using the well-known Viterbi algorithm. However, a direct implementation of an MLSD method is very costly. For example, the channel response after forward filtering is typically quite long and may contain ten or more terms. Thus, a Viterbi detector would require 2¹⁰⁻¹ states, which is impracticably complex. Therefore, other techniques have been investigated which tend to reduce complexity yet still provide results which approach those of direct MLSD methods.

One such technique is to apply the Viterbi algorithm to a reduced number of terms by canceling some of the terms with feedback. For example, by canceling all but two terms (and including the main cursor) allows the Viterbi detector to have only four states. Such detectors are referred to as reduced state sequence estimators (RSSE).

Another technique is to choose a channel response which is not a perfectly whitened target, but which has a fewer number of terms. In such systems, partial response (PR) targets have been developed. Among those targets is one referred to as enhanced extended partial response maximum likelihood (E²PRML) target. At high recording densities, it has been observed that for certain high order partial response channels (such as the E²PRML) channel, the dominant error events (the difference between two input sequences) encountered with detectors used with such partial response targets are generally of the form ±(2,-2,2). Such errors are typically caused when a tribit is shifted by one sample time or when a quadbit is mistaken as a dibit or vise versa.

A relatively new class of codes is recently being investigated. Such codes include a maximum transition run (MTR) code which has been proposed as a way of removing dominant error events from the input bit stream to the data detector. MTR codes act to increase the minimum Euclidean distance between data samples in a magnetic recording channel.

For example, an MTR=2 code limits the run of consecutive transitions in the modified waveform to two. In essence, an MTR=2 code removes all patterns of encoded data containing more than two consecutive transitions. Consequently, the MTR=2 code also removes all patterns which cause a dominant error event for MLSD detectors at high recording densities and higher order PR channels.

Using MTR constraints, one detector has been developed which is referred to as the 3D-110 detector whose performance is comparable to a fixed delay tree search with decision feedback of depth 2(FDTS/DF(2)) at high symbol densities. The detector is constructed by considering vectors of received samples (for example, three samples) in a three-dimensional space. Three planar boundaries are calculated and are used to divide the signal space into two regions, each of which corresponds to a decision of +1 or −1 for the bit currently being processed.

Thus, decision-directed timing recovery loop is typically adopted for magnetic recording channels in which the excess bandwidth is negligible. As the detector performance improves, a longer decision delay is required, and this long decision delay (sometimes referred to as long latency) limits the tracking capability of the timing recovery loop.

To enhance the distance between the true and misdetected sequence, many types of MTR codes have been proposed. Using MTR code enhances the minimum distance of an E²PRML channel from 6 to 10 and can prevent all isolated error events longer than 2 bits. However, the maximum coding rate of a practical MTR code has been found to be limited to a rate of 10/11.

To reduce the noise correlation, several types of noise-whitening methods or ME2PR4 response channels, which have the optimal channel response for minimizing noise correlation, have been proposed. However, the circuit size of ME2PRML is very large compared with E²PRML. A quasi-MTR (QMTR) code has been developed. One is a 16/17 rate QMTR code that does not enlarge the minimum Euclidian distance, but it can restrict the error events to three simple patterns. These three error events are corrected in the post-processor, which detects the error events under an E²PR4 channel response.

Signal space detectors (SSD) are formulated in a finite dimensional vector space. All possible noiseless signals are denoted as points in a vector space, and a decision boundary separating these noiseless signals into corresponding decision classes is represented by a set of hyperplanes. The detector structure includes a set of linear equations (hyperplanes) of observation samples, slicers, and a Boolean logic. The output of each linear equation is fed through a slicer whose output indicates in which side of the corresponding hyperplane the observation sample sequence is located. The Boolean logic then makes a final decision on an input symbol based on these slicer outputs.

The natural channel is equalized to an EPR4 target having a response represented by (1−D)(1+D)².

### SUMMARY OF THE INVENTION

The present invention includes two signal space detectors (SSD) for timing loop decisions for achieving less detector latency. To remove the error propagation due to the decision feedback, the SSD of the present invention is formulated by using a finite number of observation samples without utilizing any past decision. With the present invention, two SSDs are described with a decision delay of three and four. The SSD of the present invention does not make a decision based on a channel input symbol. The SSD of the present invention release estimates of ideal equalized samples by assuming the phase error detector requires ideal samples.

### BRIEF DESCRIPTION OF THE DRAWINGS

FIG. 1 illustrates a circuit diagram of the present invention;

FIG. 2 illustrates the relationship between effective signal-to-noise ratio and user bit density;

FIG. 3 illustrates the different parameters used for the signal space detector;

FIG. 4 illustrates the mean of timing function;

FIG. 5 illustrates the Bit Error Rate;

FIG. 6 is a side view of a disk drive system;

FIG. 7 is a top view of a disk drive system; and

FIGS. 8 and 9 illustrate two implementations of the present invention.

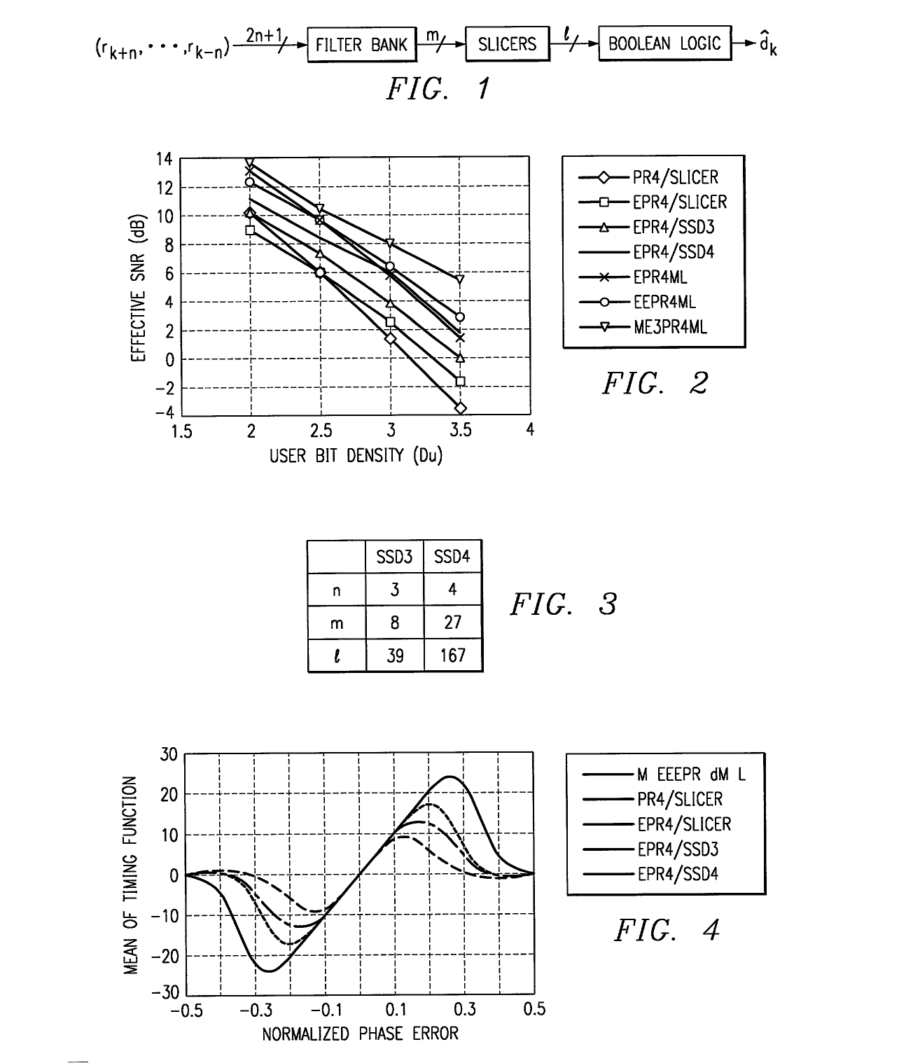

### DETAILED DESCRIPTION OF THE PRESENT INVENTION

The following invention is described with reference to figures in which similar or the same numbers represent the same or similar elements. While the invention is described in terms for achieving the invention's objectives, it can be appreciated by those skilled in the art that variations may be accomplished in view of these teachings without deviation from the spirit or scope of the invention.

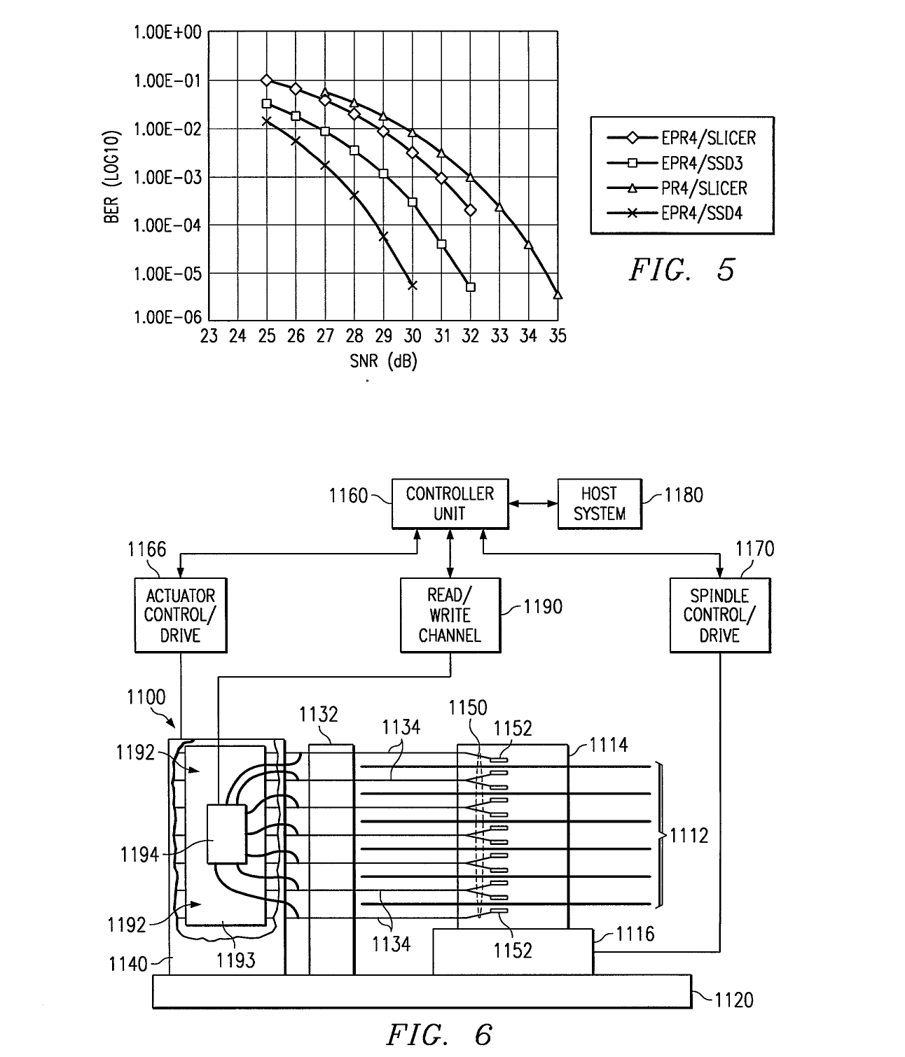

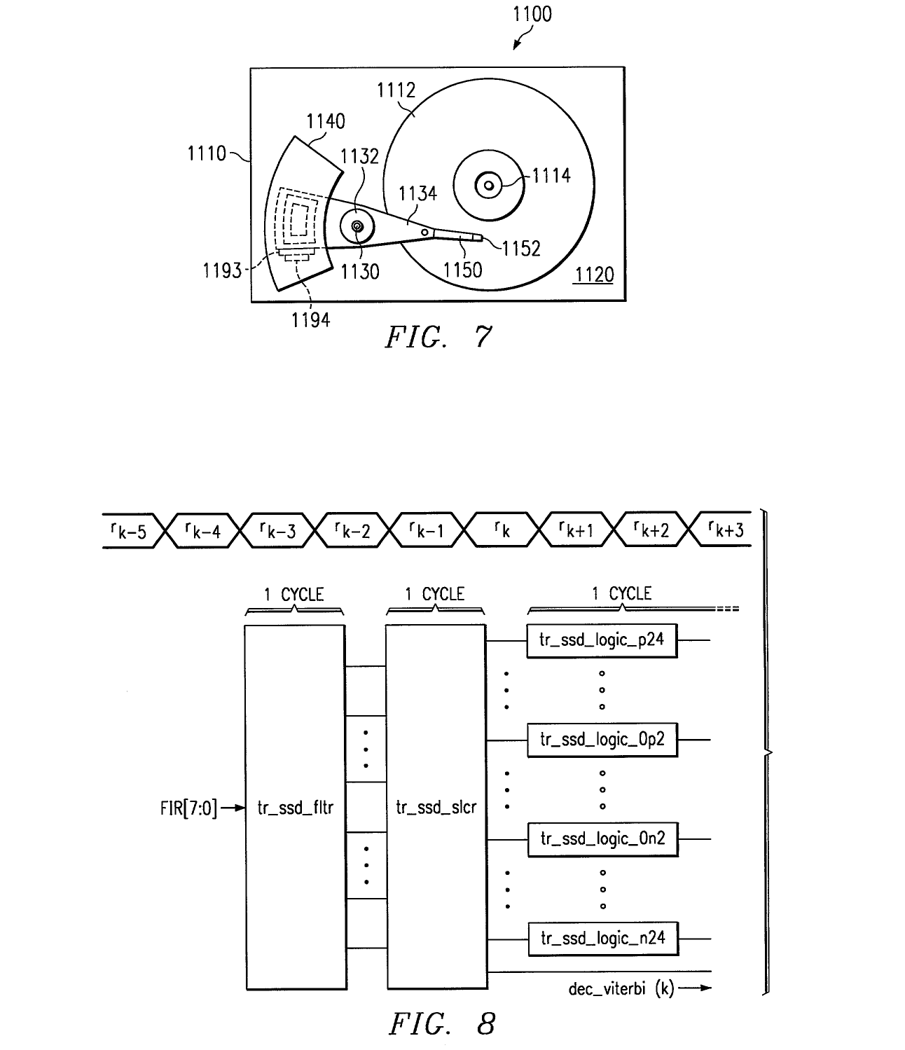

FIGS. 6 and 7 show a side and top view, respectively, of the disk drive system designated by the general reference 1100 within an enclosure 1110. The disk drive system 1100 includes a plurality of stacked magnetic recording disks 1112 mounted to a spindle 1114. The disks 1112 may be conventional particulate or thin film recording disk or, in other embodiments, they may be liquid-bearing disks. The spindle 1114 is attached to a spindle motor 1116 which rotates the spindle 1114 and disks 1112. A chassis 1120 is connected to the enclosure 1110, providing stable mechanical support for the disk drive system. The spindle motor 1116 and the actuator shaft 1130 are attached to the chassis 1120. A hub assembly 1132 rotates about the actuator shaft 1130 and supports a plurality of actuator arms 1134. The stack of actuator arms 1134 is sometimes referred to as a “comb.” A rotary voice coil motor 1140 is attached to chassis 1120 and to a rear portion of the actuator arms 1134.

A plurality of head suspension assemblies 1150 are attached to the actuator arms 1134. A plurality of inductive transducer heads 1152 are attached respectively to the suspension assemblies 1150, each head 1152 including at least one inductive write element. In addition thereto, each head 1152 may also include an inductive read element or a MR (magneto-resistive) read element. The heads 1152 are positioned proximate to the disks 1112 by the suspension assemblies 1150 so that during operation, the heads are in electromagnetic communication with the disks 1112. The rotary voice coil motor 1140 rotates the actuator arms 1134 about the actuator shaft 1130 in order to move the head suspension assemblies 1150 to the desired radial position on disks 1112.

A controller unit 1160 provides overall control to the disk drive system 1100, including rotation control of the disks 1112 and position control of the heads 1152. The controller unit 1160 typically includes (not shown) a central processing unit (CPU), a memory unit and other digital circuitry, although it should be apparent that these aspects could also be enabled as hardware logic by one skilled in the computer arts. Controller unit 1160 is connected to the actuator control/drive unit 1166 which is in turn connected to the rotary voice coil motor 1140. A host system 1180, typically a computer system or personal computer (PC), is connected to the controller unit 1160. The host system 1180 may send digital data to the controller unit 1160 to be stored on the disks, or it may request that digital data at a specified location be read from the disks 1112 and sent back to the host system 1180. A read/write channel 1190 is coupled to receive and condition read and write signals generated by the controller unit 1160 and communicate them to an arm electronics (AE) unit shown generally at 1192 through a cut-away portion of the voice coil motor 1140. The read/write channel 1190 employs the timing recovery loop of the present invention. The AE unit 1192 includes a printed circuit board 1193, or a flexible carrier, mounted on the actuator arms 1134 or in close proximity thereto, and an AE module 1194 mounted on the printed circuit board 1193 or carrier that comprises circuitry preferably implemented in an integrated circuit (IC) chip including read drivers, write drivers, and associated control circuitry. The AE module 1194 is coupled via connections in the printed circuit board to the read/write channel 1190 and also to each read head and each write head in the plurality of heads 1152.

The present invention is described through two signal space detectors for timing loop decisions with improved detector latency. The SSD of the present invention uses a finite number of observation samples without utilizing past decisions. The present invention includes two SSDs with decision delays of 3 and 4, respectively. The SSD of the present invention release estimates of ideal equalized samples by assuming the phase error detector requires ideal samples. The SSD with decision delay of 3 (SSD3) uses 7 observation samples to make a single decision on an ideal sample. These 7 observation samples include 3 look-ahead samples, 3 previous samples, and one current sample.

In contrast, the SSD with decision delay of 4 (SSD4) uses 9 observation samples, 4 look-ahead samples, 4 past samples, and one current sample. The SSD3 is tuned to white Gaussian noise (detector input noise is assumed to be white Gaussian), whereas SSD4 utilizes the noise correlation to improve detector performance. The noise correlation coefficients are obtained from a Lorentzian channel at user bit density of Du=3.

Next, the signal space detector with decision delay of 3 (SSD3) is described.

For a binary input symbol taken from {±1}, the EPR4 channel output has 5 distinct ideal sample values, {±4, ±2, 0}. The SSD3 estimates an ideal sample based on 7 observation samples.

The present invention uses an ambiguity zone detector as a preliminary detector. This ambiguity zone detector takes advantage of dividing the range of receive data into different ambiguity zones (AZ). Every readback sample falls into one of these regions. Only a few values are then allowed as legitimate output of the PR channel. For n=2, a maximum of only two values are considered as a probable output of the PR channel. Such a restriction is justified based on the fact that for a system with reasonably good signal-to-noise ratio, the probability that a received sampled output falls into an erroneous region where the actual value of the channel output is none of the allowed values is small. There is, however, a non-zero probability that the received sampled output falls into an erroneous zone and correspondingly is an error in the AZ assignment. The AZ assignments therefore translate into a list of permissible future states (PFS). The PFS corresponds to states at which survived paths could arrive. Thus, the SSD3 should only differentiate two ideal samples. Letting rₖ and dₖ be an equalized and an ideal sample, respectively, the AZD preliminary detector releases two probable ideal samples based on a single observation sample, which is represented by

$${\tilde{d}}_{k} = \{ \begin{matrix}4 if {r}_{k} > 4 \\ ( 2 , 4 ) if 2 < {r}_{k} \leq 4 \\ ( 0 , 2 ) if 0 < {r}_{k} \leq 2 \\ ( - 2 , 0 ) if - 2 < {r}_{k} \leq 0 \\ ( - 4 , - 2 if - 4 < {r}_{k} \leq - 2 \\ - 4 otherwise \end{matrix} \qquad ( 1 )$$

The sample \tilde{d}ₖ is either a single value or two ideal sample values according to the observation sample rₖ. The single-valued \tilde{d}ₖ, becomes the estimated ideal sample \hat{d}ₖ of SSD3. For a double-valued \tilde{d}ₖ the SSD3 differentiates one value from the other by using neighboring observation samples. Table 1 summarizes the coefficients of linear equations and the corresponding threshold values of slicers required for the cases of \tilde{d}ₖ (0,2) and \tilde{d}ₖ (2,4). Assuming that rₖ>0 (the case of rₖ<0 will be discussed hereinbelow), in the table, each threshold value represents a constant value compared with the output of the corresponding linear equation. Let gᵢ(cⱼ) be the slicer output defined by

$${g}_{i} ( {c}_{j} ) = \{ \begin{matrix}1 & if {g}_{i} + {c}_{j} < 0 \\ 0 & otherwise\end{matrix} \qquad ( 2 )$$

where gᵢ is the output of a linear equation and cⱼ is a threshold value. The slicer output is a binary value, either 0 or 1. When the single linear equation has corresponding multiple threshold values, each threshold value should be compared with the output of the linear equation, and a binary output denoted by gᵢ(cⱼ) should be generated.

The two Boolean logic functions b02 and b24 correspond to \tilde{d}ₖ=(0,2) and \tilde{d}ₖ=(2,4), respectively, and are defined as

$$\begin{matrix}b02 = {g}_{2} ( 2 ) \vert \\ {g}_{1} ( 2 ) \vert \\ ( {g}_{3} ( 0 ) \& {g}_{4} ( 0 ) ) \vert \\ ( {g}_{1} ( 0 ) \& {g}_{2} ( 0 ) ) \vert \\ ( {g}_{2} ( 0 ) \& {g}_{3} ( 2 ) \& {g}_{6} ( - 2 ) ) \vert \\ ( {g}_{1} ( 0 ) \& {g}_{4} ( 2 ) \& {g}_{5} ( - 2 ) ) \vert \\ ( {g}_{1} ( 0 ) \& {g}_{2} ( - 2 ) \& {g}_{6} ( - 2 ) ) \vert \\ ( {g}_{1} ( 0 ) \& {g}_{2} ( 0 ) \& {g}_{5} ( - 2 ) ) \vert \\ ( {g}_{2} ( - 4 ) \& {g}_{3} ( - 2 ) \& {g}_{4} ( 0 ) \& {g}_{6} ( 0 ) ) \vert \\ ( {g}_{1} ( - 4 ) \& {g}_{2} ( 0 ) \& {g}_{3} ( 0 ) \& {g}_{5} ( 0 ) ) \vert \\ ( {g}_{1} ( - 4 ) \& {g}_{3} ( 0 ) \& {g}_{4} ( - 2 ) \& {g}_{5} ( 0 ) ) \vert \\ ( {g}_{1} ( 0 ) \& {g}_{2} ( - 4 ) \& {g}_{4} ( 0 ) \& {g}_{6} ( 0 ) ) \vert \\ ( {g}_{1} ( 0 ) \& {g}_{2} ( - 4 ) \& {g}_{4} ( 0 ) \& {g}_{5} ( - 2 ) \& {q}_{2} ) \vert \\ ( {g}_{1} ( - 4 ) \& {g}_{2} ( 0 ) \& {g}_{3} ( 0 ) \& {q}_{3} \& {g}_{6} ( - 2 ) ) \vert \\ ( {g}_{1} ( - 2 ) \& {g}_{2} ( - 2 ) \& {g}_{3} ( - 2 ) \& {g}_{4} ( - 2 ) \& {g}_{6} ( - 2 ) \& {q}_{1} ) \vert \\ ( {g}_{1} ( - 2 ) \& {g}_{2} ( - 2 ) \& {g}_{3} ( - 2 ) \& {g}_{4} ( - 2 ) \& {q}_{4} \& {q}_{5} ( - 2 ) ) \end{matrix}$$

$$and$$

$$\begin{matrix}b24 = {g}_{1} ( - 2 ) \vert \\ {g}_{2} ( - 2 ) \vert \\ {g}_{3} ( 0 ) \vert \\ {g}_{4} ( 0 ) \vert \\ ( {g}_{1} ( - 4 ) \& {g}_{4} ( - 2 ) \& {q}_{5} ) \vert \\ ( {g}_{2} ( - 4 ) \& {g}_{3} ( 0 ) \& {g}_{6} ( - 4 ) ) \vert \\ ( {g}_{1} ( - 4 ) \& {g}_{2} ( - 4 ) \& {g}_{5} ( - 4 ) ) \vert \\ ( {g}_{1} ( - 4 ) \& {g}_{4} ( - 2 ) \& {g}_{5} ( - 4 ) ) \vert \\ ( {g}_{1} ( - 4 ) \& {g}_{2} ( - 4 ) \& {g}_{6} ( - 4 ) ) \vert \\ ( {g}_{2} ( - 4 ) \& {g}_{3} ( - 2 ) \& {q}_{6} ) ,\end{matrix}$$

where

q₁=g₅(−2)|(g₇(0)&g₅(−4)),

q₂=g₇(0)|g₅(0),

q₃=g₈(0)|g₆(0)

q₄=g₆(−2)|g₈(0)&g₆(−4)),

q₅=g₅(−4)|g₇(−2)&g₅(−6)),

q₆=g₆(−4)|g₈(−2)&g₆(−6)),

and ‘&’ and ‘|’ denote logical ‘and’ and ‘or’ operations, respectively. Thus, we can determine \hat{d}ₖ by the following equation 3.

$${\hat{d}}_{k} = \{ \begin{matrix}0 & if {\tilde{d}}_{k} = ( 0 , 2 ) & and b02 = 1 \\ 2 & if {\tilde{d}}_{k} = ( 0 , 2 ) & and b02 = 0 \\ 2 & if {\tilde{d}}_{k} = ( 2 , 4 ) & and b24 = 1 \\ 4 & if {\tilde{d}}_{k} = ( 2 , 4 ) & and b24 = 0\end{matrix} \qquad ( 3 )$$

Next is illustrated Table 1 which illustrates the coefficients of linear equations and corresponding threshold values for SSD3.

TABLE 1

| Output | | | | | | | | |
|---|---|---|---|---|---|---|---|---|
| of linear | coefficients of linear equation | | | | | | | threshold |
| equation | rₖ₋₃ | rₖ₋₂ | rₖ₋₁ | rₖ | rₖ₊₁ | rₖ₊₂ | rₖ₊₃ | values (cⱼ) |
| G₁ | 0 | 0 | 0 | 1 | 1 | 0 | 0 | −4, −2, 0, 2 |
| G₂ | 0 | 0 | 1 | 1 | 0 | 0 | 0 | −4, −2, 0, 2 |
| G₃ | 0 | 0 | 0 | 1 | −1 | 0 | 0 | −2, 0, 2 |
| G₄ | 0 | 0 | −1 | 1 | 0 | 0 | 0 | −2, 0, 2 |
| G₅ | 0 | 0 | 0 | 1 | 0 | −1 | 0 | −6, −4, −2, 0 |
| G₆ | 0 | −1 | 0 | 1 | 0 | 0 | 0 | −6, −4, −2, 0 |
| G₇ | 0 | 0 | 0 | 1 | 0 | 0 | 1 | −2, 0 |
| G₈ | 1 | 0 | 0 | 1 | 0 | 0 | 0 | −2, 0 |

Due to the underlying symmetry of the observation sample sequence, \tilde{d}ₖ=(−2,0) and \tilde{d}ₖ=(−4, −2) (where rₖ≦0), cases are easily evaluated by the same detector following the methods when rₖ>0. Note, all 7 samples are sign-changed, and the final decision \hat{d}ₖ is also sign-changed. The sign-change of observation samples are represented by equation 4.

$${f}_{i} ( {c}_{j} ) = \{ \begin{matrix}1 & if - {g}_{i} + {c}_{j} < 0 \\ 0 & otherwise\end{matrix} \qquad ( 4 )$$

where fᵢ(cⱼ) is the slicer output corresponding to the case of rₖ≦0. To save linear equations, equation 4 can be restated as equation 5.

$${f}_{i} ( {c}_{j} ) = \{ \begin{matrix}1 & if {g}_{i} - {c}_{j} \geq 0 \\ 0 & otherwise\end{matrix} \qquad ( 5 )$$

Equation 5 can be represented by equation 6.

$${f}_{i} ( {c}_{j} ) = \{ \begin{matrix}1 & if {g}_{i} ( - {c}_{j} ) = 0 \\ 0 & otherwise\end{matrix} \qquad ( 6 )$$

From equation 6, we can see that no additional hardware is required for linear equations. Even though some slicer outputs can directly be obtained from the case of rₖ>0 simply by a logical inversion, additional slicers are required for f₁(−4), f₂(−4), f₅(−6), f₅(−4), f₅(−2), f₆(−6), f₆(−4), f₆(−2), f₇(−2), and f₈(−2). The Boolean logic function is the same as in the case of rₖ>0 with the inputs fᵢ(cⱼ) instead of gᵢ(cⱼ).

Signal Space Detector with Decision Delay of 4

The signal space detector performance can be improved by utilizing noise correlation. The noise correlation coefficients for SSD4 have been obtained from the Lorentzian channel at the use bit density of 3. Similarly to SSD3, the ambiguity zone detection is used as a preliminary detector. As described previously, the SSD4 uses 9 observation samples including 4 past samples, 4 look-ahead samples, and one current sample. The obtained linear equations and corresponding threshold values for the case of rₖ>0 are summarized in Table 2.

TABLE 2

| output of | | | | | | | | | | |
|---|---|---|---|---|---|---|---|---|---|---|
| linear | coefficients of linear equation | | | | | | | | | |
| equation | rₖ₋₄ | rₖ₋₃ | rₖ₋₂ | rₖ₋₁ | rₖ | rₖ₊₁ | rₖ₊₂ | rₖ₊₃ | rₖ₊₄ | threshold values (cⱼ) |
| g₁ | 0 | 0 | 0 | 0 | 1 | 1 | 0 | 0 | 0 | −4, −2, 0, 2 |
| g₂ | 0 | 0 | 0 | 1 | 1 | 0 | 0 | 0 | 0 | −4, −2, 0, 2 |
| g₃ | 0 | 0 | 0 | −1 | 1 | −1 | 0 | 0 | 0 | −1, 1 |
| g₄ | 0 | 0 | 0 | 0 | 1 | 0 | 1 | 0 | 0 | −2, 0, 2 |
| g₅ | 0 | 0 | 0 | 0 | 1 | 0 | −2 | 0 | 0 | −7, −5, −3, −1, 3 |
| g₆ | 0 | 0 | 0 | 0 | 1 | 0 | 0 | −1 | 0 | −4, −2, 0, 2 |
| g₇ | 0 | 0 | 0 | 0 | 0 | −1 | −1 | 0 | 0 | −4, −2, 0, 2, 4 |
| g₈ | 0 | 0 | 0 | 0 | 2 | 1 | 1 | 2 | 0 | −4, −2, 0, 2 |
| g₉ | 0 | 0 | 0 | 1 | 1 | 1 | 0 | 1 | 0 | −6, −4, −2, 0, 2 |
| g₁₀ | 0 | 0 | 0 | 1 | 4 | 0 | −1 | 0 | 4 | −21, −11, −1 |
| g₁₁ | 0 | 0 | 1 | 0 | 1 | 0 | 0 | 0 | 0 | −2, 0, 2 |
| g₁₂ | 0 | 0 | 1 | 0 | 1 | −1 | 0 | −1 | 0 | 0 |
| g₁₃ | 0 | 0 | 1 | 1 | 2 | 0 | −2 | −1 | −1 | −14, −12, −10, −8, 0, 2, 4 |
| g₁₄ | 0 | 0 | 2 | 1 | 4 | 0 | 2 | 2 | 0 | −12, −8 |
| g₁₅ | 0 | 0 | −1 | −1 | 0 | 0 | 0 | 0 | 0 | −4, −2, 0, 2, 4 |
| g₁₆ | 0 | 0 | −2 | 0 | 1 | 0 | 0 | 0 | 0 | −7, −5, −3, −1, 3 |
| g₁₇ | 0 | 0 | −2 | −1 | 1 | −1 | 1 | 2 | 0 | −14, −10, −8, −6, −4, −2, 0, 2, |
| | | | | | | | | | | 4, 6, 8, 10 |
| g₁₈ | 0 | 0 | −2 | −2 | 0 | −4 | −1 | −2 | 0 | −6, −4, −2, 0, 2, 4, 6, 8, 12 |
| g₁₉ | 0 | 1 | 0 | 1 | 1 | 1 | 0 | 0 | 0 | −6, −4, −2, 0, 2 |
| g₂₀ | 0 | 2 | 1 | 1 | 2 | 0 | 0 | 0 | 0 | −4, −2, 0, 2 |
| g₂₁ | 0 | 2 | 2 | 0 | 4 | 1 | 2 | 0 | 0 | −12, −8 |
| g₂₂ | 0 | 2 | 1 | −1 | 1 | −1 | −2 | 0 | 0 | −14, −10, −8, −6, −4, −2, 0, 2, |
| | | | | | | | | | | 4, 6, 8, 10 |
| g₂₃ | 0 | −1 | 0 | 0 | 1 | 0 | 0 | 0 | 0 | −4, −2, 0, 2 |
| g₂₄ | 0 | −1 | 0 | −1 | 1 | 0 | 1 | 0 | 0 | 0 |
| g₂₅ | 0 | −2 | −1 | −4 | 0 | −2 | −2 | 0 | 0 | −6, −4, −2, 0, 2, 4, 6, 8, 12 |
| g₂₆ | −1 | −1 | −2 | 0 | 2 | 1 | 1 | 0 | 0 | −14, −12, −10, −8, 0, 2, 4 |
| g₂₇ | 4 | 0 | −1 | 0 | 4 | 1 | 0 | 0 | 0 | −21, −11, −1 |

The Boolean logic function is given by

$$\begin{matrix}b02 = ( {g}_{1} ( - 2 ) \& {g}_{2} ( - 2 ) \& p1 \& p2 \& p3 \& p4 ) \vert \\ ( {g}_{1} ( - 2 ) \& {g}_{2} ( - 4 ) \& {g}_{3} ( - 1 ) \& p5 \& p6 \& p7 \& p8 \& p9 \& p10 ) \vert \\ ( {g}_{1} ( - 4 ) \& {g}_{2} ( - 4 ) \& {g}_{3} ( 1 ) \& p11 \& p12 \& p13 \& p14 \vert \\ {g}_{2} ( 2 ) \vert \\ ( {g}_{2} ( 0 ) \& {g}_{3} ( - 1 ) \& p15 \& p16 \& p17 ) \vert \\ ( {g}_{1} ( 0 ) \& {g}_{2} ( - 4 ) \& p18 \& p19 \& p20 ) \vert \\ ( {g}_{1} ( 0 ) \& {g}_{3} ( - 1 ) \& p21 \& p22 \& p23 ) \vert \\ ( {g}_{1} ( - 4 ) \& {g}_{2} ( 0 ) \& p24 \& p25 \& p26 ) \vert \\ ( {g}_{1} ( - 4 ) \& {g}_{2} ( - 2 ) \& {g}_{3} ( - 1 ) \& p27 \& p28 \& p29 \& p30 \& p31 \& p32 ) \vert \\ ( {g}_{1} ( 0 ) \& {g}_{2} ( - 2 ) \& p33 ) \vert \\ ( {g}_{1} ( 0 ) \& {g}_{2} ( - 4 ) \& p34 \& p35 \& p36 ) \vert \\ ( {g}_{1} ( - 4 ) \& {g}_{2} ( 0 ) \& p37 \& p38 \& p39 ) \vert \\ {g}_{1} ( 2 ) \vert \\ ( {g}_{1} ( 0 ) \& {g}_{2} ( 0 ) ) \vert \\ ( {g}_{1} ( - 2 ) \& {g}_{2} ( 0 ) \& p40 ) \vert \\ ( {g}_{1} ( - 2 ) \& {g}_{2} ( - 2 ) \& p41 \& p42 \& p43 \& p44 ) \\ and \\ b24 = ( {g}_{1} ( - 4 ) \& q1 \& q2 ) \vert \\ ( {g}_{1} ( - 4 ) \& {g}_{3} ( - 1 ) \& q3 ) \vert \\ {g}_{2} ( - 2 ) \vert \\ ( {g}_{2} ( - 4 ) \& q4 \& q5 ) \vert \\ ( {g}_{2} ( - 4 ) \& {g}_{3} ( - 1 ) \& q6 ) \vert \\ ( \& {g}_{2} ( - 4 ) \& q7 ) \vert \\ ( {g}_{1} ( - 4 ) \& q8 \& q9 ) \vert \\ {g}_{1} ( - 2 ) \vert \\ ( {g}_{1} ( - 4 ) \& {g}_{2} ( - 4 ) \& q10 ) \vert \\ ( {g}_{2} ( - 4 ) \& q11 \& q12 ) , \\ where \\ p1 = {g}_{4} ( - 2 ) \\ p2 = {g}_{15} ( 0 ) \vert \\ ( {g}_{15} ( - 2 ) \& {g}_{22} ( - 6 ) ) \vert \\ ( {g}_{25} ( - 2 ) \& {g}_{22} ( - 10 ) ) \vert \\ ( {g}_{15} ( - 2 ) \& {g}_{8} ( 2 ) \& {g}_{22} ( - 10 ) ) \vert \\ ( {g}_{8} ( 2 ) \& {g}_{25} ( - 6 ) \& {g}_{22} ( - 14 ) ) \\ p3 = {g}_{11} ( - 2 ) \vert \\ {g}_{23} ( 2 ) \vert \\ {g}_{9} ( 2 ) \vert \\ ( {g}_{5} ( - 5 ) \& {g}_{9} ( 0 ) ) \vert \\ ( {g}_{9} ( 0 ) \& {g}_{13} ( - 10 ) ) \vert \\ ( {g}_{5} ( - 5 ) \& {g}_{9} ( - 2 ) \& {g}_{13} ( - 8 ) ) \vert \\ ( {g}_{8} ( 2 ) \& {g}_{10} ( - 11 ) \& {g}_{13} ( - 12 ) ) \\ p4 = {g}_{16} ( - 1 ) \vert \\ {g}_{17} ( 0 ) \vert \\ ( {g}_{7} ( - 2 ) \& {g}_{17} ( - 6 ) ) \\ p5 = {g}_{16} ( 3 ) \vert \\ ( {g}_{16} ( - 1 ) \& {g}_{19} ( - 4 ) ) \\ p6 = {g}_{15} ( 0 ) \\ p7 = {g}_{4} ( - 2 ) \\ p8 = {g}_{16} ( 3 ) \vert \\ {g}_{7} ( - 2 ) \\ ( {g}_{7} ( - 4 ) \& {g}_{17} ( 6 ) ) \\ p9 = {g}_{15} ( 4 ) \vert \\ {g}_{22} ( - 2 ) \vert \\ ( {g}_{8} ( 2 ) \& {g}_{22} ( - 6 ) ) \vert \\ ( {g}_{25} ( 4 ) \& {g}_{22} ( - 6 ) ) \vert \\ ( {g}_{8} ( 2 ) \& {g}_{25} ( 0 ) \& {g}_{22} ( - 10 ) ) \\ p10 = {g}_{16} ( 3 ) \vert \\ {g}_{17} ( 6 ) \vert \\ ( {g}_{7} ( - 2 ) \& {g}_{17} ( 0 ) ) \\ p11 = {g}_{7} ( 2 ) \vert \\ ( {g}_{7} ( 0 ) \& {g}_{17} ( 10 ) ) \vert \\ ( {g}_{18} ( 6 ) \& {g}_{17} ( 6 ) ) \vert \\ ( {g}_{7} ( 0 ) \& {g}_{20} ( - 4 ) \& {g}_{17} ( 6 ) ) \vert \\ ( {g}_{20} ( - 4 ) \& {g}_{18} ( 2 ) \& {g}_{17} ( 2 ) ) \\ p12 = {g}_{11} ( - 2 ) \vert \\ {g}_{22} ( 4 ) \vert \\ ( {g}_{25} ( 12 ) \& {g}_{22} ( 0 ) ) \vert \\ ( {g}_{21} ( - 8 ) \& {g}_{22} ( 0 ) ) \vert \\ ( {g}_{24} ( 0 ) \& {g}_{25} ( 8 ) \& {g}_{21} ( - 12 ) \& {g}_{22} ( - 4 ) ) \\ p13 = {g}_{4} ( 2 ) \vert \\ {g}_{17} ( 4 ) \vert \\ ( {g}_{18} ( 12 ) \& {g}_{17} ( 0 ) ) \vert \\ ( {g}_{14} ( - 8 ) \& {g}_{17} ( 0 ) ) \vert \\ ( {g}_{12} ( 0 ) \& {g}_{18} ( 8 ) \& {g}_{14} ( - 12 ) \& {g}_{17} ( - 4 ) ) \\ p14 = {g}_{15} ( 2 ) \vert \\ ( {g}_{15} ( 0 ) \& {g}_{22} ( 10 ) ) \vert \\ ( {g}_{25} ( 6 ) \& {g}_{22} ( 6 ) ) \vert \\ ( {g}_{15} ( 0 ) \& {g}_{8} ( - 4 ) \& {g}_{22} ( 6 ) ) \vert \\ ( {g}_{8} ( - 4 ) \& {g}_{25} ( 2 ) \& {g}_{22} ( 2 ) ) \\ p15 = {g}_{7} ( 4 ) \vert \\ ( {g}_{7} ( 2 ) \& {g}_{17} ( 8 ) ) \vert \\ ( {g}_{18} ( 6 ) \& {g}_{17} ( 4 ) ) \vert \\ ( {g}_{7} ( 2 ) \& {g}_{20} ( 0 ) \& {g}_{17} ( 4 ) ) \vert \\ ( ( {g}_{20} ( 0 ) \& {g}_{18} ( 2 ) \& {g}_{17} ( 0 ) ) \\ p16 = {g}_{16} ( - 1 ) \vert \\ ( {g}_{16} ( - 5 ) \& {g}_{19} ( - 2 ) ) \\ p17 = {g}_{16} ( - 1 ) \vert \\ {g}_{7} ( 4 ) \vert \\ ( {g}_{7} ( 2 ) \& {g}_{17} ( - 2 ) ) \\ p18 = {g}_{5} ( - 1 ) \vert \\ ( {g}_{5} ( - 5 ) \& {g}_{9} ( 0 ) ) \\ p19 = {g}_{15} ( 0 ) \vert \\ ( {g}_{15} ( - 2 ) \& {g}_{22} ( 4 ) ) \vert \\ ( {g}_{25} ( 0 ) \& {g}_{22} ( 0 ) ) \vert \\ ( {g}_{15} ( - 2 ) \& {g}_{8} ( 0 ) \& {g}_{22} ( 0 ) ) \vert \\ ( {g}_{8} ( 0 ) \& {g}_{25} ( - 4 ) \& {g}_{22} ( - 4 ) ) \\ p20 = {g}_{23} ( 0 ) \vert \\ {g}_{9} ( 0 ) \vert \\ ( {g}_{11} ( 0 ) \& {g}_{23} ( - 2 ) ) \vert \\ ( {g}_{5} ( - 1 ) \& {g}_{9} ( - 2 ) ) \vert \\ ( {g}_{9} ( - 4 ) \& {g}_{13} ( 2 ) ) \vert \\ ( {g}_{10} ( - 1 ) \& {g}_{13} ( 0 ) \\ p21 = {g}_{5} ( - 1 ) \vert \\ {g}_{15} ( 4 ) \vert \\ ( {g}_{15} ( 2 ) \& {g}_{22} ( - 2 ) ) \\ p22 = {g}_{5} ( - 1 ) \vert \\ ( {g}_{5} ( - 5 ) \& {g}_{9} ( - 2 ) ) \\ p23 = {g}_{15} ( 4 ) \vert \\ ( {g}_{15} ( 2 ) \& {g}_{22} ( 8 ) ) \vert \\ ( {g}_{25} ( 6 ) \& {g}_{22} ( 4 ) ) \vert \\ ( {g}_{15} ( 2 ) \& {g}_{8} ( 0 ) \& {g}_{22} ( 4 ) ) \vert \\ ( {g}_{8} ( 0 ) \& {g}_{25} ( 2 ) \& {g}_{22} ( 0 ) ) \\ p24 = {g}_{11} ( 2 ) \vert \\ {g}_{6} ( 0 ) \vert \\ {g}_{5} ( 3 ) \vert \\ {g}_{13} ( 4 ) \vert \\ ( {g}_{9} ( 0 ) \& {g}_{13} ( 0 ) ) \\ p25 = {g}_{7} ( 0 ) \\ p26 = {g}_{5} ( 3 ) \vert \\ ( {g}_{5} ( - 1 ) \& {g}_{9} ( - 2 ) ) \\ p27 = {g}_{5} ( 3 ) \vert \\ {g}_{22} ( 6 ) \vert \\ ( {g}_{15} ( - 2 ) \& {g}_{22} ( 0 ) ) \\ p28 = {g}_{11} ( - 2 ) \vert \\ p29 = {g}_{7} ( 4 ) \vert \\ {g}_{17} ( - 2 ) \vert \\ ( {g}_{20} ( 2 ) \& {g}_{17} ( - 6 ) ) \vert \\ ( {g}_{18} ( 4 ) \& {g}_{17} ( - 6 ) ) \vert \\ ( {g}_{20} ( 2 ) \& {g}_{18} ( 0 ) \& {g}_{17} ( - 10 ) ) \\ p30 = {g}_{7} ( 0 ) \\ p31 = {g}_{5} ( 3 ) \vert \\ {g}_{15} ( - 2 ) \vert \\ ( {g}_{15} ( - 4 ) \& {g}_{22} ( 6 ) ) \\ p32 = {g}_{5} ( 3 ) \vert \\ ( {g}_{5} ( - 1 ) \& {g}_{9} ( - 4 ) ) \\ p33 = {g}_{4} ( 2 ) \vert \\ {g}_{23} ( 2 ) \vert \\ {g}_{16} ( - 1 ) \vert \\ {g}_{26} ( 4 ) \vert \\ ( {g}_{19} ( 0 ) \& {g}_{26} ( 0 ) ) \\ p34 = {g}_{16} ( 3 ) \vert \\ ( {g}_{16} ( - 1 ) \& {g}_{19} ( - 2 ) ) \\ p35 = {g}_{15} ( 0 ) \\ p36 = {g}_{4} ( 2 ) \vert \\ {g}_{23} ( 0 ) \vert \\ {g}_{16} ( 3 ) \vert \\ {g}_{26} ( 4 ) \vert \\ ( {g}_{19} ( 0 ) \& {g}_{26} ( 0 ) ) \\ p37 = {g}_{6} ( 0 ) \vert \\ {g}_{19} ( 0 ) \vert \\ ( {g}_{4} ( 0 ) \& {g}_{6} ( - 2 ) ) \vert \\ ( {g}_{16} ( - 1 ) \& {g}_{19} ( - 2 ) ) \vert \\ ( {g}_{19} ( - 4 ) \& {g}_{26} ( 2 ) ) \vert \\ ( {g}_{27} ( - 1 ) \& {g}_{26} ( 0 ) ) \\ p38 = {g}_{7} ( 0 ) \vert \\ ( {g}_{7} ( - 2 ) \& {g}_{17} ( 4 ) ) \vert \\ ( {g}_{18} ( 0 ) \& {g}_{17} ( 0 ) ) \vert \\ ( {g}_{7} ( - 2 ) \& {g}_{20} ( 0 ) \& {g}_{17} ( 0 ) ) \vert \\ ( {g}_{20} ( 0 ) \& {g}_{18} ( - 4 ) \& {g}_{17} ( - 4 ) ) \\ p39 = {g}_{16} ( - 1 ) \vert \\ ( {g}_{16} ( - 5 ) \& {g}_{19} ( 0 ) ) \\ p40 = {g}_{11} ( 2 ) \vert \\ {g}_{6} ( 2 ) \vert \\ {g}_{5} ( - 1 ) \vert \\ {g}_{13} ( 4 ) \vert \\ ( {g}_{9} ( 0 ) \& {g}_{13} ( 0 ) ) \\ p41 = {g}_{4} ( - 2 ) \vert \\ {g}_{6} ( 2 ) \vert \\ {g}_{19} ( 2 ) \vert \\ ( {g}_{16} ( - 5 ) \& {g}_{19} ( 0 ) ) \vert \\ ( {g}_{19} ( 0 ) \& {g}_{26} ( - 10 ) ) \vert \\ ( {g}_{16} ( - 5 ) \& {g}_{19} ( - 2 ) \& {g}_{26} ( - 8 ) ) \vert \\ ( {g}_{20} ( 2 ) \& {g}_{27} ( - 11 ) \& {g}_{26} ( - 12 ) ) \\ p42 = {g}_{5} ( - 1 ) \vert \\ {g}_{22} ( 0 ) \vert \\ ( {g}_{15} ( - 2 ) \& {g}_{22} ( - 6 ) ) \\ p43 = {g}_{11} ( - 2 ) \\ p44 = {g}_{7} ( 0 ) \vert \\ ( {g}_{7} ( - 2 ) \& {g}_{17} ( - 6 ) ) \vert \\ ( {g}_{18} ( - 2 ) \& {g}_{17} ( - 10 ) ) \vert \\ ( {g}_{7} ( - 2 ) \& {g}_{20} ( 2 ) \& {g}_{17} ( - 10 ) ) \vert \\ ( {g}_{20} ( 2 ) \& {g}_{18} ( - 6 ) \& {g}_{17} ( - 14 ) ) \\ q1 = {g}_{15} ( 0 ) \vert \\ ( {g}_{15} ( - 2 ) \& {g}_{22} ( 0 ) ) \vert \\ ( {g}_{25} ( 0 ) \& {g}_{22} ( - 4 ) ) \vert \\ ( {g}_{15} ( - 2 ) \& {g}_{8} ( - 2 ) \& {g}_{22} ( - 4 ) ) \vert \\ ( {g}_{8} ( - 2 ) \& {g}_{25} ( - 4 ) \& {g}_{22} ( - 8 ) ) \\ q2 = {g}_{23} ( - 2 ) \vert \\ {g}_{9} ( - 2 ) \vert \\ ( {g}_{11} ( - 2 ) \& {g}_{23} ( - 4 ) ) \vert \\ ( {g}_{5} ( - 7 ) \& {g}_{9} ( - 4 ) ) \vert \\ ( {g}_{9} ( - 4 ) \& {g}_{13} ( - 12 ) ) \vert \\ ( {g}_{5} ( - 7 ) \& {g}_{9} ( - 6 ) \& {g}_{13} ( - 10 ) ) \vert \\ ( {g}_{9} ( - 4 ) \& {g}_{10} ( - 21 ) \& {g}_{13} ( - 14 ) ) \\ q3 = {g}_{15} ( 4 ) \vert \\ ( {g}_{15} ( 2 ) \& {g}_{22} ( 4 ) ) \vert \\ ( {g}_{25} ( 6 ) \& {g}_{22} ( 0 ) ) \vert \\ ( {g}_{15} ( 2 ) \& {g}_{8} ( - 2 ) \& {g}_{22} ( 0 ) ) \vert \\ ( {g}_{8} ( - 2 ) \& {g}_{25} ( 2 ) \& {g}_{22} ( - 4 ) ) \\ q4 = {g}_{16} ( - 3 ) \\ q5 = {g}_{16} ( - 3 ) \\ q6 = {g}_{7} ( 4 ) \vert \\ ( {g}_{7} ( 2 ) \& {g}_{17} ( 4 ) ) \vert \\ ( {g}_{18} ( 6 ) \& {g}_{17} ( 0 ) ) \vert \\ ( {g}_{7} ( 2 ) \& {g}_{20} ( - 2 ) \& {g}_{17} ( 0 ) ) \vert \\ ( {g}_{20} ( - 2 ) \& {g}_{18} ( 2 ) \& {g}_{17} ( - 4 ) ) \\ q7 = {g}_{5} ( - 3 ) \\ q8 = {g}_{5} ( - 3 ) \\ q9 = {g}_{5} ( - 3 ) \\ q10 = {g}_{16} ( - 3 ) \\ q11 = {g}_{6} ( - 2 ) \vert \\ {g}_{19} ( - 2 ) \vert \\ ( {g}_{4} ( - 2 ) \& {g}_{6} ( - 4 ) ) \vert \\ ( {g}_{16} ( - 7 ) \& {g}_{19} ( - 4 ) ) \vert \\ ( {g}_{19} ( - 4 ) \& {g}_{26} ( - 12 ) ) \vert \\ ( {g}_{16} ( - 7 ) \& {g}_{19} ( - 6 ) \& {g}_{26} ( - 10 ) ) \vert \\ ( {g}_{19} ( - 4 ) \& {g}_{27} ( - 21 ) \& {g}_{26} ( - 14 ) ) \\ q12 = {g}_{7} ( 0 ) \vert \\ ( {g}_{7} ( - 2 ) \& {g}_{17} ( 0 ) ) \vert \\ ( {g}_{18} ( 0 ) \& {g}_{17} ( - 4 ) ) \vert \\ ( {g}_{7} ( - 2 ) \& {g}_{20} ( - 2 ) \& {g}_{17} ( - 4 ) ) \vert \\ ( {g}_{20} ( - 2 ) \& {g}_{18} ( - 4 ) \& {g}_{17} ( - 8 ) ) . \end{matrix}$$

With rₖ<0, the procedure is the same as described for SSD3; namely, all 9 observation samples are sign-changed, and the final decision is also sign-changed. For a high-speed application, the same steps as explained in equations (4) and (6) can be applied to remove the sign-change of observation samples at the cost of hardware increase of slicers and Boolean logic.

Performance Comparison.

Next, a performance comparison will be discussed. The performance of the signal space detector (SSD) is compared with other known detectors including slicers combined with PR4 and EPR4 equalization as denoted by PR4/slicer and EPR4/slicer, respectively. For all of the detectors illustrated, the input symbol sequence is encoded by the QMTR code. FIG. 5 illustrates the error rates curves for Lorentzian pulse. The channel noise is presumed to be 100% additive white Gaussian noise (AWGN). As can be seen, the SSD3 and SSD4 have significant gain over any channel slicer combination. The user bit recording density used in this comparison was 3.

The linear operating range of a timing function has been examined for various detectors. The timing function illustrated in FIG. 4 is considered that of a conventional PRML scheme. A second order timing recovery loop is assumed, and the linear operating range is determined by the positive slope region of the mean of the timing function. FIG. 4 shows the mean of the timing function, and the SSD provides wider operating range than slicers.

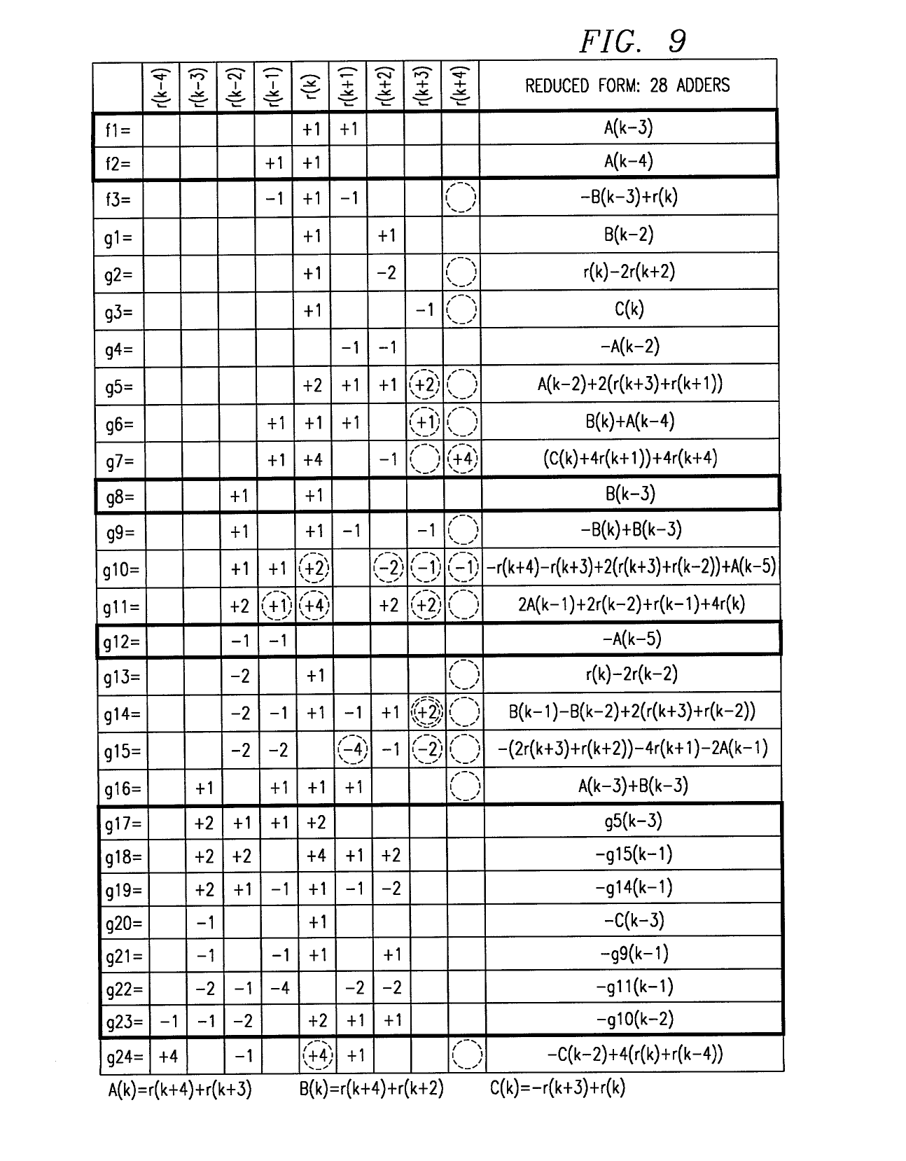

FIGS. 8 and 9 illustrate two implementations of the present invention.

In conclusion, two signal space detectors for timing recovery loop have been illustrated for decision delays of 3 and 4. Detector performance has been compared with other detectors for various aspects such as bit error rate and linear operating range of the timing recovery loop. Thus, the present invention provides advantages as described above.

1. A data detector for use in a circuit comprising:
a data detector wherein the data detector detects data encoded according to a code having time varying constraints.

2. A data detector for use in a circuit comprising:
a preliminary ambiguity zone detector releasing a few probable ideal samples;
a signal space detector includes;
a filter bank with a finite number of input samples, slicers, and
a Boolean logic circuit;

3. A signal space detector operating on EPR4 channel with comprising:
a preliminary ambiguity zone detector;
a signal space detector releasing detected ideally equalized samples.
